(19) United States
(12) Patent Application Publication
(10) Pub. No.: US 2008/0080516 A1
(43) Pub. Date: Apr. 3, 2008

(54) METHOD AND APPARATUS OF ADAPTIVE SEQUENCE NUMBERING IN A WIRELESS COMMUNICATION SYSTEM

(75) Inventors: Mohammed Sammour, Montreal (CA); Stephen E. Terry, Northport, NY (US); Arty Chandra, Manhasset Hills, NY (US); Jin Wang, Central Islip, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/864,659

(22) Filed: Sep. 28, 2007

Related U.S. Application Data
(60) Provisional application No. 60/827,513, filed on Sep. 29, 2006.

(51) Int. Cl. H04L 12/56

(52) U.S. Cl. 370/394

(57) ABSTRACT

A method and apparatus of adaptive sequence numbering in a wireless communication system includes determining whether or not a packet to be transmitted will be segmented. Based upon the segmentation determination, a determination as to whether or not to include a radio link controller (RLC) specific automatic repeat request (ARQ) sequence number (SN) to the packet is made. An indicator is added to indicate whether or not the RLC-specific ARQ SN is included in the packet. The packet is transmitted, and an acknowledgment (ACK) is received for the transmitted packet.

### CROSS REFERENCE TO RELATED APPLICATION

This application claims the benefit of U.S. Provisional Application No. 60/827,513, filed Sep. 29, 2006, which is incorporated by reference herein as if fully set forth.

### FIELD OF INVENTION

The present invention is related to wireless communication systems.

### BACKGROUND

The Third Generation Partnership Project (3GPP) has recently initiated the Long Term Evolution (LTE) program to bring new technology, new network architecture and configuration, and new applications and services to wireless cellular networks. The LTE program is intended to provide improved spectral efficiency, reduced latency, faster user experiences and richer applications and services with less associated costs.

Within a 3GPP system, a radio link control (RLC) layer provides radio link management for the radio interface. The RLC sub-layer consists of RLC entities, of which there are three types: Transparent Mode (TM), Unacknowledged Mode (UM), and Acknowledged Mode (AM) RLC entities. The AM mode of RLC supports Error Correction/Recovery via Automatic Repeat Request (ARQ), while the TM and UM modes do not provide error correction and/or recovery. RLC functions include the following: Error Correction/Recovery via ARQ, Flow control between RLC transmitter (Tx) and receiver (Rx), Flow control between a gateway (aGW) and evolved Node-B (eNB) (for future study (FFS)), In-sequence Delivery (Re-ordering), Duplicate Detection, Segmentation, Re-segmentation, Concatenation (FFS), SDU Discard (FFS).

In Release 6 of the 3GPP Standard, the AM and UM RLC perform segmentation of RLC service data units (SDUs) into fixed-size RLC packet data units (PDUs). Currently, RLC PDUs have a semi-static, configured, fixed size, and PDUs are identified via adding RLC PDU sequence numbers (SNs). For LTE, various segmentation schemes have been proposed where the RLC PDU size will not be fixed, but changing depending on the underlying radio conditions.

The RLC sub-layer's services and functions include a segmentation and re-segmentation function at the RLC transmitter (Tx), which may require a reassembly function at the RLC receiver (Rx). Also included is an error correction through ARQ function, where the RLC Rx identifies errors, such as via acknowledgments, while the RLC Tx retransmits erroneous packets. Additionally, an in-sequence delivery of RLC SDUs function exists at the RLC Rx, which tends to require a sequence numbering function at the RLC Tx.

Above the RLC sub-layer resides the packet data convergence protocol (PDCP) sub-layer. The PDCP sub-layer also has a sequence numbering function at the PDCP transmitting entity. Such sequence numbering will be needed for ciphering and integrity protection purposes, as well as re-ordering of RLC SDUs during handover.

In general, RLC sequence numbering can be done at either one of two levels. It can be RLC SDU sequence numbering, whereby each SDU of a logical channel increments the SDU SN, or it can be RLC PDU sequence numbering, whereby each PDU of a logical channel increments the PDU SN.

Since the RLC supports segmentation & re-segmentation, the RLC segments need to be identified so that the RLC receiver can perform SDU reassembly. If RLC SDU sequence numbering is employed, a segment numbering or identification scheme should be employed in order to identify the segments of an SDU. Such a scheme has a scope that is limited to a single SDU only, though, in the sense that segment numbers/identifiers are restarted for every SDU. This constitutes a ‘nested’ model (multiple levels) of numbering, (i.e., segment numbering within SDU numbering). If RLC PDU sequence numbering is employed, there is no need for an additional segment identification scheme, since the PDU SN readily identifies the segment.

In Release 6 of the 3GPP standard, the PDU sequence numbering method is utilized in the RLC. For LTE, an additional requirement is the support for re-segmentation, a function where the PDU sequence numbering model becomes inflexible. Hence, since re-segmentation is required, and since re-segmentation favors the ‘nested’ numbering models, (i.e., multiple levels of numbering), where segment identifiers are used either in addition to SDU numbers or in addition to PDU number providing more flexibility, the ‘nested’ numbering models offer an advantage for LTE, as opposed to the single numbering model such as having only a single level of PDU numbering.

RLC SDU identifiers, such as an SDU SN, are likely to be employed by the RLC in LTE, due to the need for supporting re-segmentation and reassembly. Furthermore, the term SDU SN may also be referred to as ARQ SN, or SSN. It should be noted that the term ARQ SN also sometimes refers to the PDU SN.

However, hereinafter, the term SDU SN or ARQ SN refers to the sequence number assigned to an RLC SDU, (i.e., PDCP PDU) typically, but can also refer to the sequence number assigned to a group of RLC SDUs under some concatenation schemes. Additionally, the SDU SN or ARQ SN needs to exist, (i.e., be copied), in the RLC segment or RLC PDU, but does not necessarily need to be present in the RLC SDU, even though it will be incremented per RLC SDU. The terminology ARQ SN may also be used in place of SDU SN. The ARQ SN may be directly derived from a higher layer SN, such as the PDCP SN.

In some proposals, it has been considered to reuse the PDCP SN to identify an RLC SDU instead of assigning an additional ARQ SN. Other proposals prefer introducing an additional RLC-specific ARQ SN.

In the case of small IP packets, such as VoIP and TCP ACKs, since segmentation is not needed (or if segmentation is needed, segmentation will result in a small number of segments), reusing the PDCP SN has an advantage. However, for large packets such as FTP data packets, since segmentation may be needed and can result in a large number of segments, using an RLC-specific ARQ SN has an advantage.

Accordingly, each scheme possesses an advantage over the other depending on whether the resulting number of segments is small or large. For example, PDCP SN reuse is superior when there is no segmentation or when segmentation results in a small number of segments, while ARQ SN is superior when segmentation results in a large number of segments.

FIG. 1 is a frame diagram 100 depicting a large packet case RLC-specific ARQ SN transmission with segmentation needed. Although only two segments are shown, it should be noted that any number of segments may be included.

FIG. 2 is a frame diagram 200 depicting a small packet case RLC-specific ARQ SN transmission when segmentation is not needed. As shown in FIG. 2, an efficiency weakness exists when segmentation is not needed or when the resulting number of segments is small, (i.e., small packets).

FIG. 3 is a frame diagram 300 depicting a large packet case reusing PDCP SN transmission. FIG. 3 shows an efficiency weakness when segmentation is needed and when the resulting number of segments is large, (i.e., large packets). Again, although only two segments are shown, it should be noted that any number of segments may be included.

FIG. 4 is a frame diagram 400 depicting a small packet case reusing PDCP SN transmission. As shown in FIG. 4, reusing the PDCP SN has an efficiency advantage when segmentation is not needed or when the resulting number of segments is small, (i.e., small packets).

Accordingly, it would be advantageous to provide a method and apparatus for adaptive sequence numbering in a wireless communication system.

### SUMMARY

A method and apparatus of adaptive sequence numbering in a wireless communication system are disclosed. A determination is made whether or not a packet to be transmitted will be segmented. Based upon the segmentation determination, a determination as to whether or not to include a radio link controller (RLC) specific automatic repeat request (ARQ) sequence number (SN) to the packet is made. An indicator is added to indicate whether or not the RLC-specific ARQ SN is included in the packet. The packet is transmitted, and an acknowledgment (ACK) is received for the transmitted packet.

### BRIEF DESCRIPTION OF THE DRAWINGS

A more detailed understanding of the invention may be had from the following description of a preferred embodiment, given by way of example and to be understood in conjunction with the accompanying drawings wherein:

FIG. 1 is a frame diagram depicting a large packet case RLC-specific ARQ SN transmission with segmentation needed;

FIG. 2 is a frame diagram depicting a small packet case RLC-specific ARQ SN transmission when segmentation is not needed;

FIG. 3 is a frame diagram depicting a large packet case reusing PDCP SN transmission;

FIG. 4 is a frame diagram depicting a small packet case reusing PDCP SN transmission;

FIG. 5 shows an example wireless communication system including a plurality of wireless transmit/receive units (WTRUs), a base station, and a radio network controller (RNC);

FIG. 6 is a functional block diagram of a WTRU and the base station of FIG. 5;

FIG. 7 is a flow diagram of a method of adaptive sequence numbering;

FIGS. 8, 9A, 9B, 10, 11A, 11B, 12, and 13 are example frame diagrams; and

FIGS. 14, 15, and 16 are example signal diagrams.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

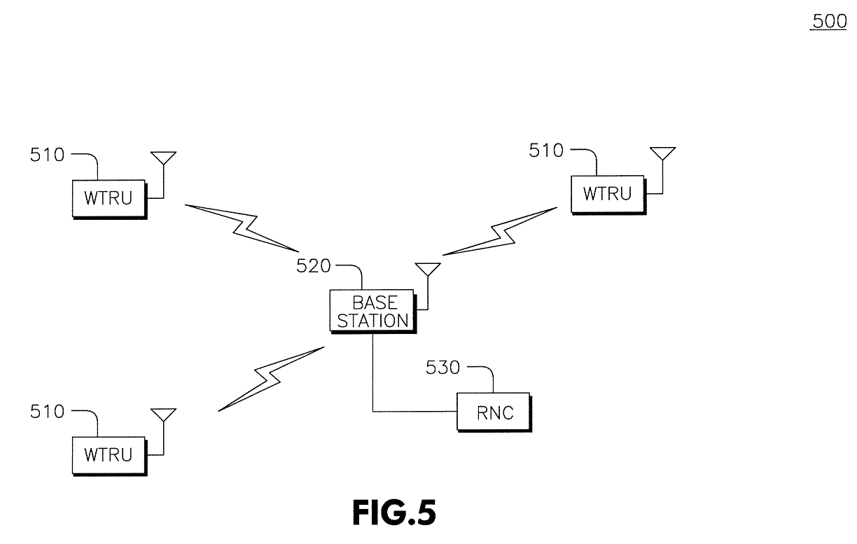

FIG. 5 shows a wireless communication system 500 including a plurality of WTRUs 510, a base station 520, and an RNC 530. As shown in FIG. 5, the WTRUs 510 are in communication with the base station 520, which is in communication with the RNC 530. Although three WTRUs 510, one base station 520, and one RNC 530 are shown in FIG. 5, it should be noted that any combination of wireless and wired devices may be included in the wireless communication system 500. For example, although the RNC 530 is shown in the wireless communication system 500, the RNC 530 may not be included in an LTE system.

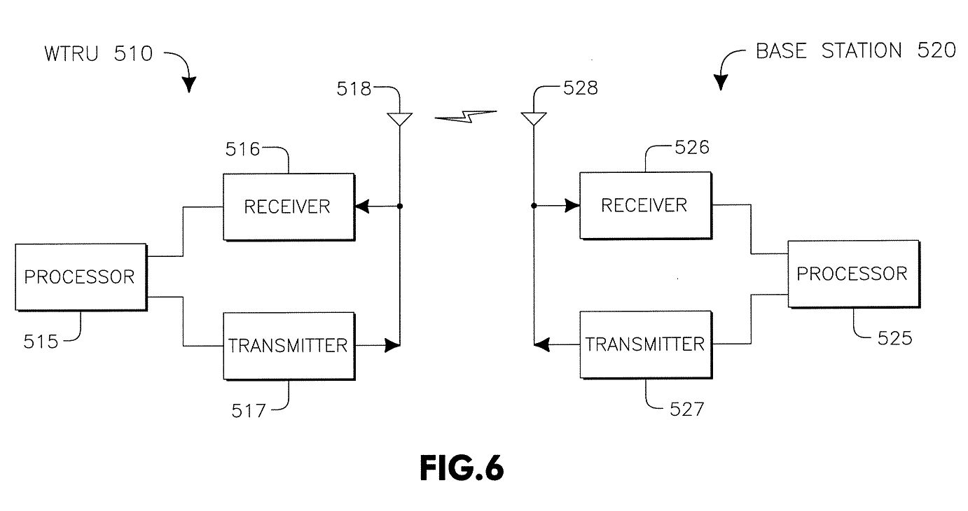

FIG. 6 is a functional block diagram 600 of a WTRU 510 and the base station 520 of the wireless communication system 500 of FIG. 5. As shown in FIG. 5, the WTRU 510 is in communication with the base station 520 and both are configured to perform a method of adaptive sequence numbering.

In addition to the components that may be found in a typical WTRU, the WTRU 510 includes a processor 515, a receiver 516, a transmitter 517, and an antenna 518. The processor 515 is configured to perform an adaptive sequence numbering procedure. The receiver 516 and the transmitter 517 are in communication with the processor 515. The antenna 518 is in communication with both the receiver 516 and the transmitter 517 to facilitate the transmission and reception of wireless data.

In addition to the components that may be found in a typical base station, the base station 520 includes a processor 525, a receiver 526, a transmitter 527, and an antenna 528. The processor 525 is configured to perform an adaptive sequence numbering procedure. The receiver 526 and the transmitter 527 are in communication with the processor 525. The antenna 528 is in communication with both the receiver 526 and the transmitter 527 to facilitate the transmission and reception of wireless data.

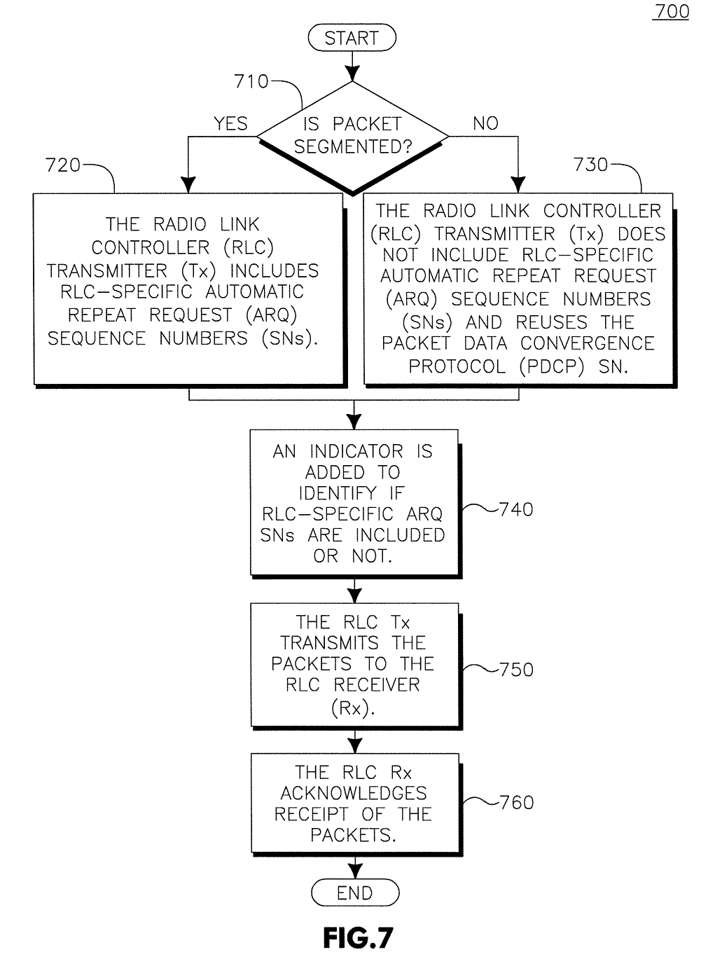

FIG. 7 is a flow diagram of a method 700 of adaptive sequence numbering. In step 710, a determination is made as to whether or not the packet is segmented or whether segmentation is needed. For example, in the case of small IP packets, such as VoIP and TCP ACKs, and the like, segmentation may not be needed, or even if segmentation occurs, it is likely to result in a small number of segments. On the other hand, for large packets, such as FTP data packets, segmentation may be needed and may result in a large number of segments.

If segmentation is performed (step 710), then the RLC Tx includes RLC-specific ARQ SNs (step 720), which may be added to the frame. Since the PDCP SN typically is longer in size than an RLC-specific ARQ SN, the RLC-specific ARQ SN is used. In this case, the PDCP SN exists only in the first segment. The RLC-specific ARQ SN may be incremented for every SDU that will be segmented. Alternatively, the RLC-specific ARQ SN may be incremented for every SDU regardless of segmentation, but may be only added to, or inserted in, the SDUs that will actually be segmented.

Conversely, if segmentation is not performed in step 710, then the RLC Tx does not include RLC-specific ARQ SNs, and instead reuses the PDCP SN (step 730). In this scenario, the overhead associated with reusing the PDCP SN may be less than the associated overhead with including an RLC-specific ARQ SN.

Whether an RLC-specific ARQ SN is used or the PDCP SN is reused, it must be indicated to a receiver. Accordingly, in step 740, an indicator is added to the frame to identify whether an RLC-specific ARQ SN is included or not. This indicator may be in the form of an explicit bit or field added to the frame, or indicated in other header information. A bit indicator may be anywhere in an RLC or MAC header. It may also be part of the segmentation information, such as a segment ID, or alternatively it may be implied. For example, a particular bit or field may include a pre-defined setting that signifies whether or not the ARQ SN is included

An indicator bit, such as an “S”-bit, may also be a bit that indicates whether an RLC SDU is segmented or not. In this case, if it the RLC SDU is segmented, than the bit may also indicate the segment that will contain the RLC-specific ARQ SNs. If the RLC SDU is not segmented, then the bit should indicate that the SDU does not contain RLC-specific ARQ SNs.

As mentioned, a field identifying the segments, (e.g., Seg. ID), or the information contained in the field may be used to identify whether an RLC-specific ARQ SN is present or not. For example, information such as the segment number, the total number of segments, the segment size, and the like may be used to identify whether the RLC-specific ARQ SN is present or not.

In step 750, the RLC Tx transmits the packets, segmented or otherwise, to the RLC receiver (Rx), which acknowledges (ACKs) receipt of the packets (step 760). This ACK may be either a positive or negative ACK by specifying either the PDCP SN, or the RLC-specific ARQ SN and Seg. IDs, depending on the scenario.

For example, if the RLC Rx detects a gap in the PDCP SN, such as following the reassembly operation, the RLC Rx may generate a report that negatively ACKs the missing PDCP SNs. On the other hand, the RLC Rx may positively acknowledge specific PDCP SNs received, or cumulatively received up to a particular PDCP SN. For example, the RLC Rx may indicate a particular PDCP SN that indicates all PDCP SNs prior to that particular PDCP SN have been successfully received.

If the RLC Rx detects a gap in received segments of a given packet before the reassembly operation, the RLC Rx may generate a report that negatively ACKs the missing Seg. IDs of a particular RLC-specific ARQ SN or PDCP SN. Likewise for received packets, the RLC Rx may positively ACK Seg. IDs of particular RLC-specific ARQ SNs or PDCP SNs.

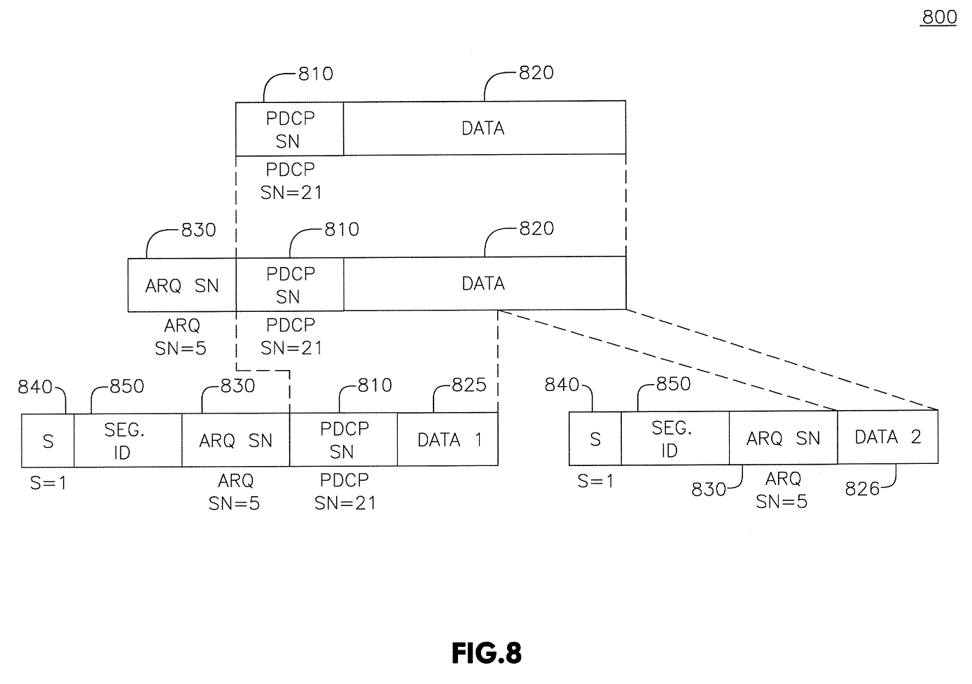

Referring now to FIG. 8, there is shown an example frame diagram 800. In FIG. 8, segmentation is performed. The frame diagram 800 includes a PDCP SN 810 and a data field 820. For purposes of example, the PDCP SN is shown as equal to twenty-one (21), however, the PDCP SN may be any number. As shown in FIG. 8, an RLC-specific ARQ SN (ARQ SN 830) is inserted into the frame. Again, for purposes of example, the ARQ SN 830 is shown as having a value of five (5), however the ARQ SN 830 may include any value.

As shown in FIG. 8, the data field 820 is segmented into two data fields: data1 825 and data2 826. The ARQ SN 830 is added, or copied, in each segment. Additionally, an S-bit 840, and a Seg. ID 850 is added to each segment. The S-bit 840, having, by way of example, a value of one (1), indicates the presence of an RLC-specific ARQ. Additionally, the Seg. IDs 850 may include byte offsets and segment size, segment number, segment version, and the like.

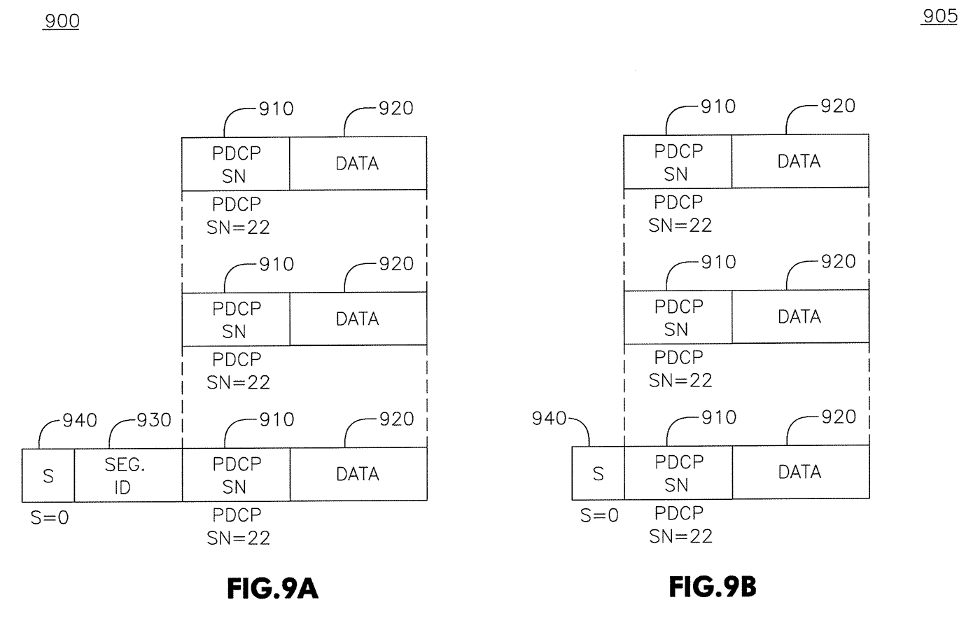

In FIGS. 9A and 9B, segmentation does not occur, such as in a small packet case. Each frame, 900 and 905, includes a PDCP SN 910, having a value of twenty-two (22), and a data field 920. In this case, no RLC-specific ARQ SN is added or inserted into the frame, and an S Bit 940, having a value of zero (0), is added to indicate that there is no RLC-specific ARQ SN. The PDCP SN 910 is reused in this case for reassembly. A Seg. ID 930, similar to Seg. ID 830 of FIG. 8 is inserted in the frame shown in FIG. 9A. In this case, the Seg. ID 930 may identify whether, for example, the segment is the first or last segment. However, the Seg. ID may not always be inserted, as shown in FIG. 9B.

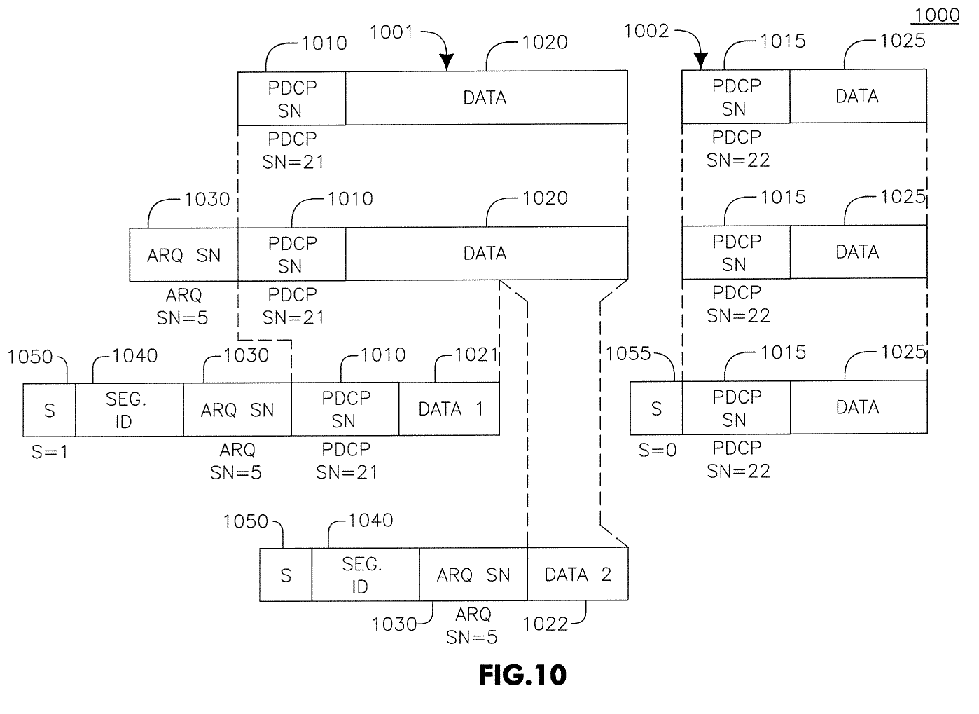

Referring now to FIG. 10, a large packet 1001, where segmentation will occur, is followed by a small packet 1002, where segmentation does not occur. The large packet 1001 includes a PDCP SN 1010, having a value of twenty-one (21) and a data field 1020. The small packet 1002 has a PDCP SN 1015 having a value of twenty-two (22) and a data field 1025.

An RLC-specific ARQ SN 1030, having a value of five (5) is added to the large packet 1001. The data field 1020 of the large packet 1001 is segmented into data1 1021 and data2 1022 fields, and Seg. IDs 1040 and S bits 1050 are added to both segments. In the large packet 1001, the S bit has a value of one (1), indicating the presence of the RLC-specific ARQ SN 1030. In the small packet 1002, the PDCP SN 1015 is reused, and an S bit 1055 having a value of zero (0) is added to indicate that an RLC-specific ARQ SN is not included.

The method 700 of FIG. 7 may also be utilized in cases where concatenation occurs to a frame. In this scenario, the PDCP SNs may be reduced, or compressed, when multiple PDCP PDUs, or RLC SDUs, are concatenated. In one example, the PDCP SN of the first packet and the total number of packets to be concatenated may be specified.

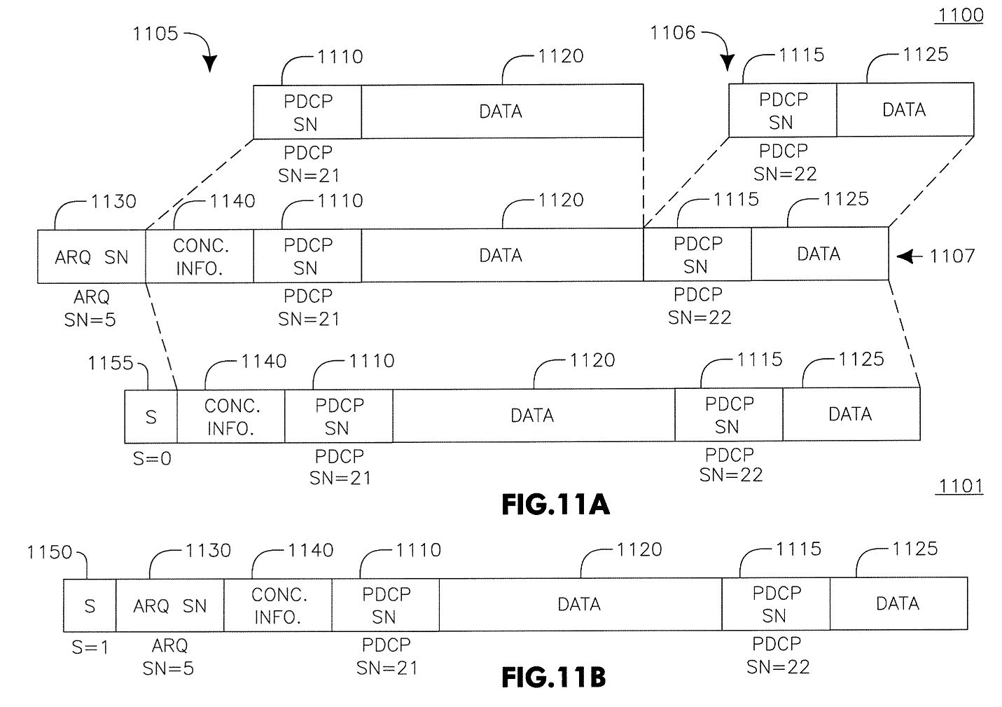

FIGS. 11A and 11B are example frame diagrams 1100 and 1101, respectively, where concatenation is employed. As shown in FIGS. 11A and 11B, two packets, designated 1105 and 1106, will be concatenated into a concatenated frame 1107, however segmentation does not occur. Packet 1105 includes a PDCP SN 1110, having a value of twenty-one (21), and a data field 1120, while packet 1106 includes a PDCP SN 1115, having a value of twenty-two (22), and a data field 1125. An RLC-specific ARQ SN 1130, having a value of five (5), may be inserted into the concatenated packet, (e.g., as shown in FIG. 11B) or may not be included, (e.g., as shown in FIG. 11A). Additionally, a concatenation information field (Conc. Info field 1140) is added to the concatenated packet 1107.

Since the ARQ SN 1130 is not included in the concatenated packet shown in FIG. 11A, an S bit 1150, having a value of zero (0) is added to the concatenated packet to show the absence of an RLC-specific ARQ SN. However, since the ARQ SN 1130 is inserted into the concatenated packet shown in FIG. 11B, an S bit 1155, having a value of one (1), is inserted into the concatenated packet to indicate the presence of an RLC-specific ARQ SN. The insertion of the ARQ SN 1130 in the concatenated packet shown in FIG. 11B may enable the ARQ process to identify and retransmit an entire concatenated packet if necessary, as opposed to having to identify and retransmit individual constituent RLC SDUs of the concatenated packet.

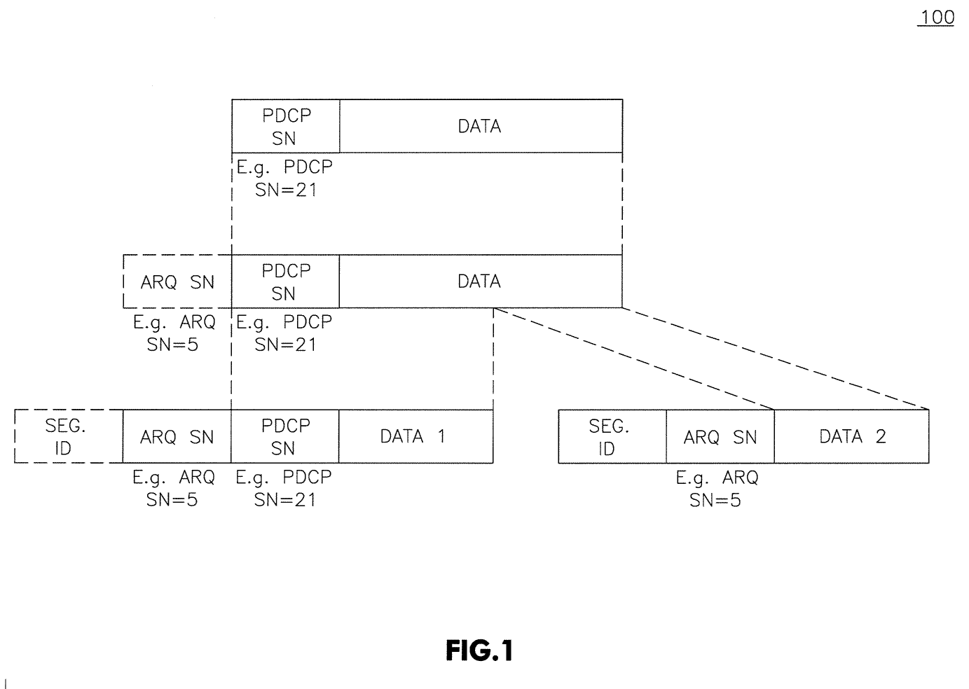

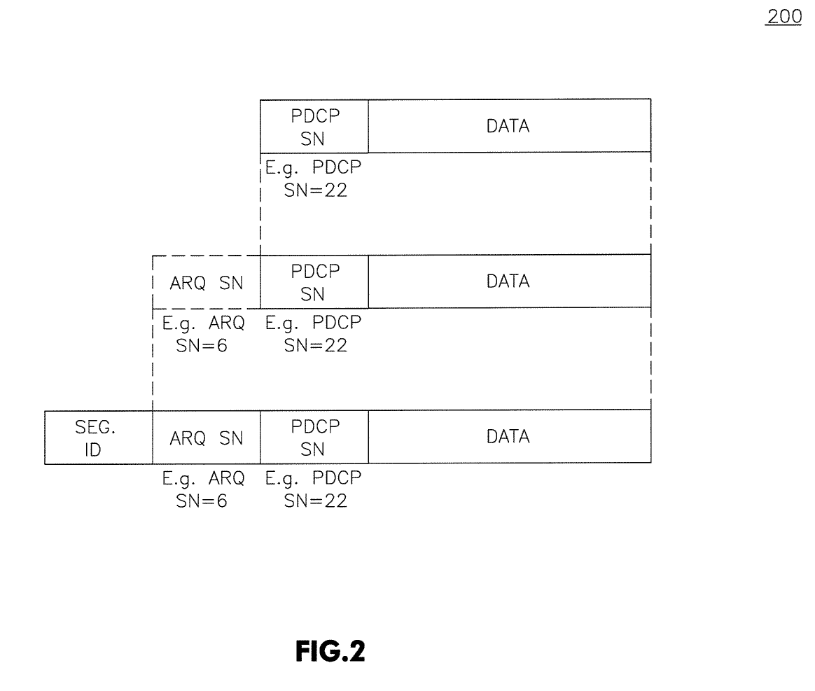

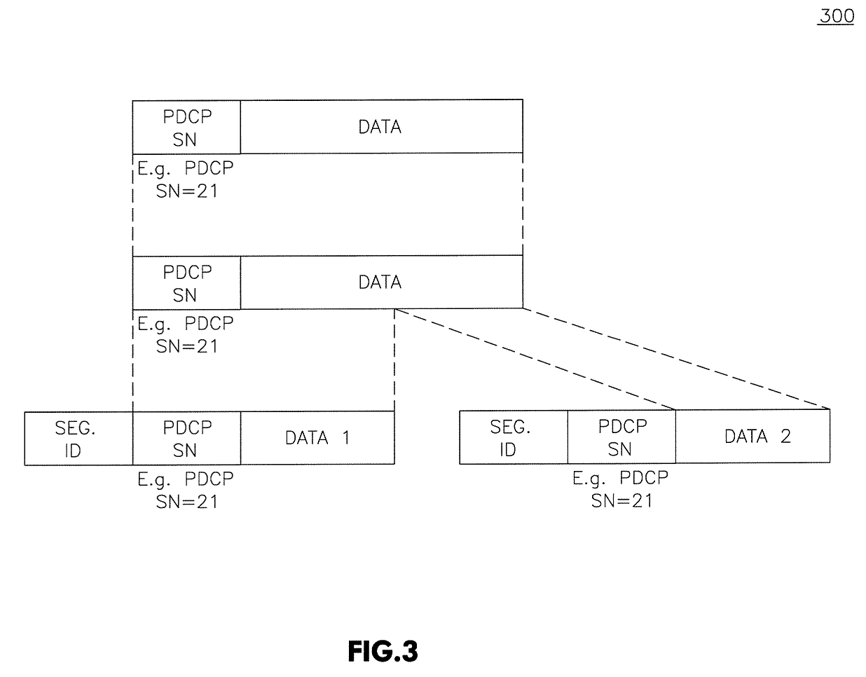

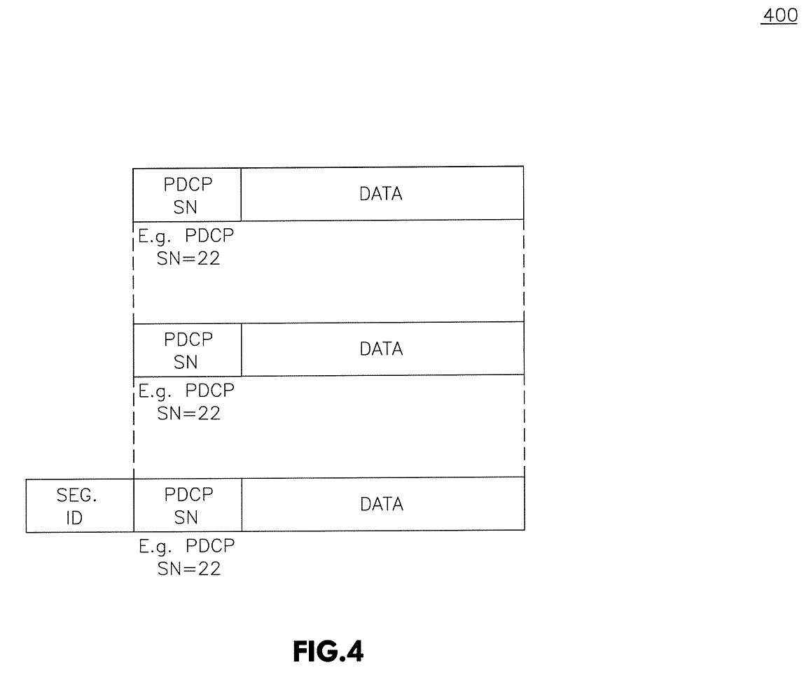

Although the full PDCP SN is shown for each PDCP PDU, this may not necessarily be the case. As described above, when multiple PDCP PDUs are concatenated, the PDCP SN may be compressed, or reduced. Additionally, although no Seg. ID is shown in FIG. 1A or 1B, it can be included if desired.

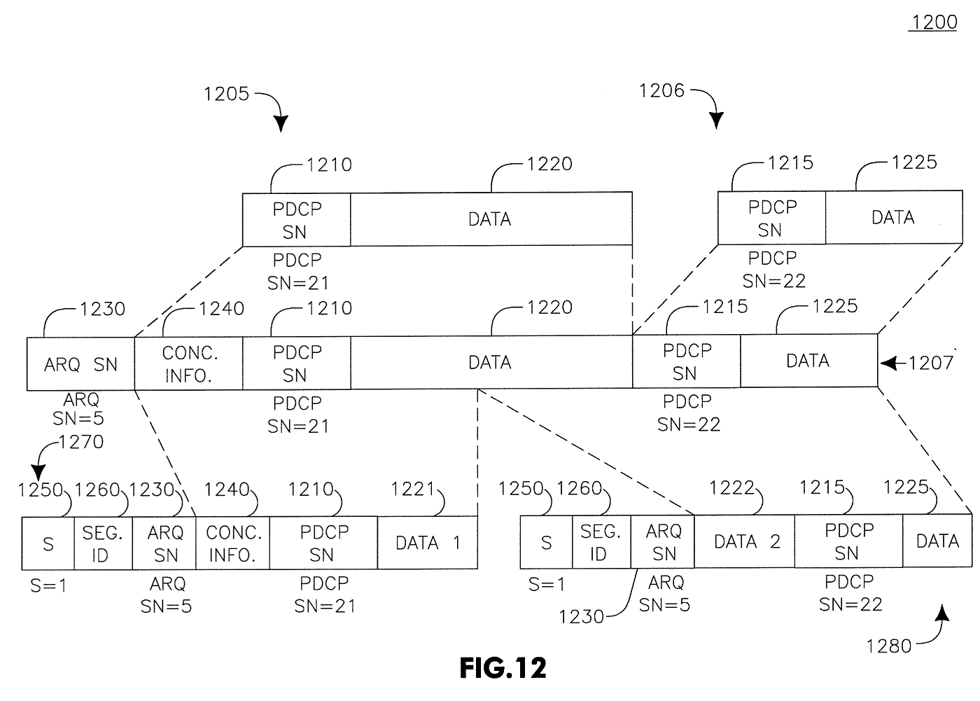

FIG. 12 is an example frame diagram 1200 where concatenation and segmentation are performed. As shown in FIG. 12, two packets, designated 1205 and 1206, will be concatenated into a concatenated frame 1207, which will be segmented. Packet 1205 includes a PDCP SN 1210, having a value of twenty-one (21), and a data field 1220, while packet 1206 includes a PDCP SN 1215, having a value of twenty-two (22), and a data field 1225. An RLC-specific ARQ SN 1230, having a value of five (5), is inserted into the concatenated packet 1207, and a Conc. Info. field 1240 is added to the concatenated packet 1207. The Conc. Info. field 1240 may include information such as a length indicator of the concatenated packet, an extension bit indicating if there is another concatenated packet, and the like.

For purposes of example, packet 1205 may be considered a large packet which will be segmented. Accordingly, the data field 1220 is segmented into data1 field 1221 and data2 field 1222, and the concatenated packet 1207 is segmented into two segments, designated 1270 and 1280. The first segment 1270 contains the ARQ SN 1230, the Conc. Info. field 1240, the, PDCP SN 1210 and the data1 field 1221. In addition, an S bit 1250, having a value of one (1) to indicate the presence of an RLC-specific ARQ SN, is inserted, as well as a Seg. ID 1260 field. The second segment 1280 contains the S bit 1250, having a value of one (1) to indicate the presence of an RLC-specific ARQ SN, Seg. ID 1260 field, the ARQ SN 1230, the data2 field 1222, and additionally the PDCP SN 1215 and the data field 1225.

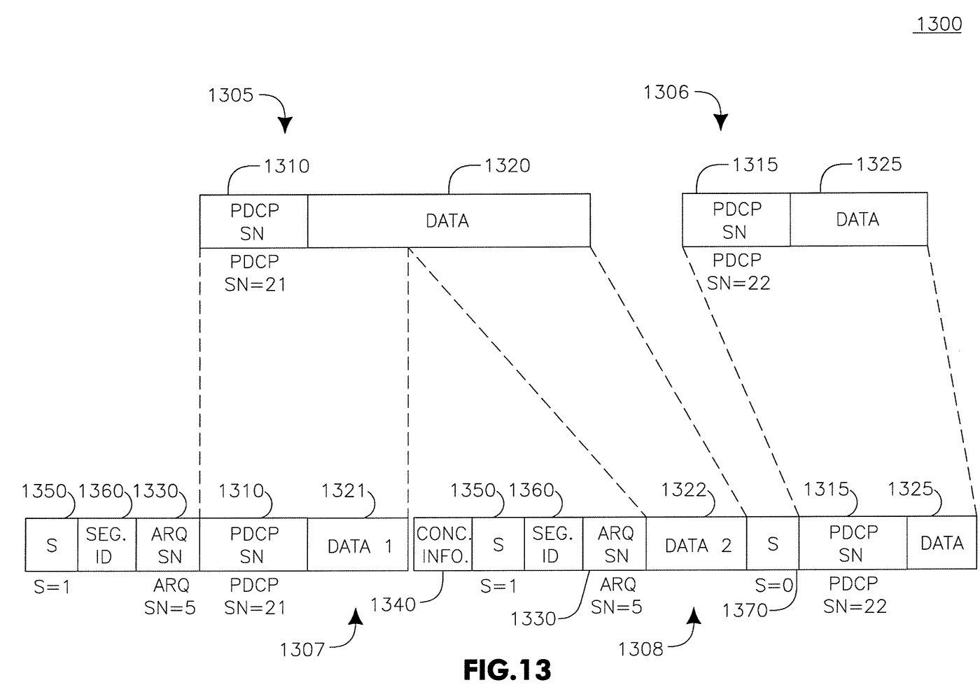

FIG. 13 is an example frame diagram 1300 where segmentation occurs prior to concatenation. As shown in FIG. 13, two packets, designated 1305 and 1306 are to be concatenated. For purposes of example, packet 1305 may be a large packet that will be segmented, while packet 1306 may be a small packet that will not be segmented. Packet 1305 includes a PDCP SN 1310, having a value of twenty-one (21), and a data field 1320, while packet 1306 includes a PDCP SN 1315, having a value of twenty-two (22), and a data field 1325.

The data field 1320 is segmented into data1 field 1321 and data2 field 1322, and the packet 1305 is segmented into two segments, designated 1307 and 1308. The first segment 1307 includes the PDCP SN 1310 and the data1 field 1321. In addition, an ARQ SN 1330, having a value of five (5), an S bit 1350, having a value of one (1) to indicate the presence of an RLC-specific ARQ SN, and a Seg. ID 1360 field are inserted in segment 1307.

The second segment 1308 is concatenated with the packet 1306 and therefore includes a Conc. Info. field 1340, the S bit 1350, the Seg. ID 1360, the ARQ SN 1330, the data2 field 1322, an S-bit 1370, having a value of zero (0), and the PDCP SN 1315 and data field 1325 of the packet 1306. The S-bit 1370 includes a value of zero to indicate that there is no ARQ SN associated with packet 1306 in the concatenated packet.

The locations and contents of the fields shown in FIGS. 8-13 are provided purely by way of example, and may appear in any order to suit particular segmentation and concatenation scenarios.

In an alternative embodiment to method 700 of FIG. 7, a static or semi-static configuration may be used. In this scenario, certain logical channels, such as ARQ queues, may utilize an RLC-specific ARQ SN, while other channels reuse the PDCP SN. A negotiation phase, or setup phase, may be required to allow the RLC Tx and RLC Rx to send messages specifying the SN mode of operation. Once the specification is done, the RLC Tx and RLC Rx may not need to use a field or bit, indicating whether or not an RLC-specific ARQ SN is present as they will be informed from the configuration.

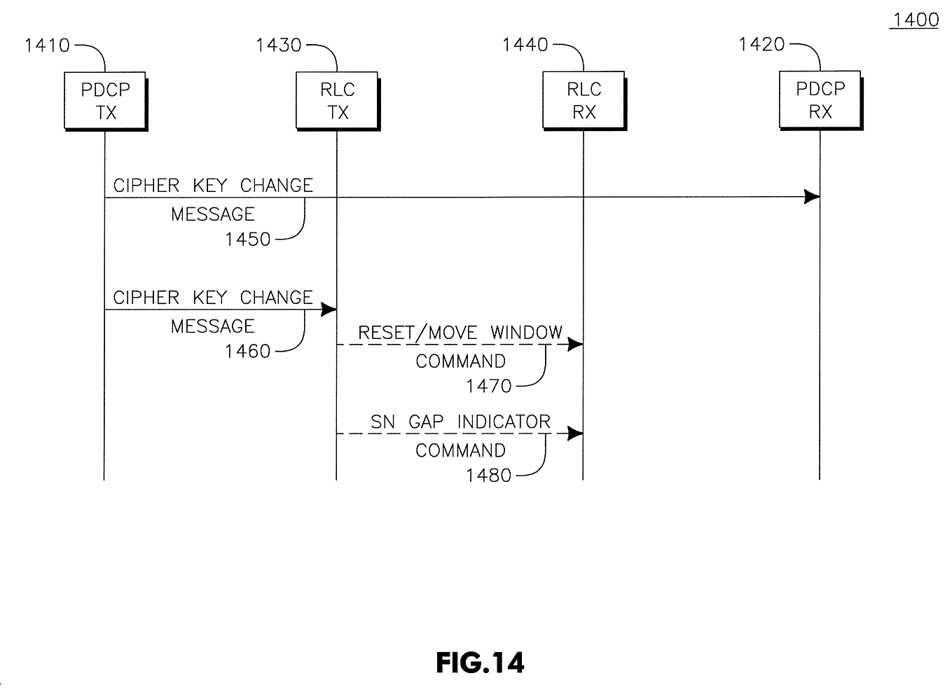

Since PDCP reuse may create a dependency issue between RLC ARQ and ciphering, an RLC may need to be made aware of ciphering SN resets and may need to re-establish ARQ. FIG. 14 is an example signal diagram 1400 depicting signaling wherein ciphering key changes or resets are addressed.

Whenever a decision is made to change or reset ciphering keys, the PDCP Tx side should communicate with the PDCP Rx side to inform it of changes in ciphering keys. Additionally the PDCP Tx should notify the RLC Tx. As shown in FIG. 14, a PDCP Tx 1410, a PDCP Rx 1420, an RLC Tx 1430, and an RLC Rx 1440 are capable of communication with one another. Accordingly, the PDCP Tx 1410 transmits a cipher key change message (1450) to the PDCP Rx 1420. The cipher key change message (1450) contains the changes to the ciphering keys. Also, the PDCP Tx 1410 transmits a cipher key change message (1460) to the RLC Tx 1430. The cipher key change message (1460) contains the new PDCP SN that will be used. The RLC Tx 1430 then informs the RLC Rx 1440. For example, the RLC Tx 1430 may transmit a reset/move window command (1470) to the RLC Rx 1440. The reset/move window command (1470) may be in the form of a Move Receive Command (MRW), and signals the RLC Rx 1440 to either reset or move its window to the new PDCP SN that will be used. If the RLC Tx 1430 is aware of the next packet to be transmitted, (e.g., the next packet is in the RLC Tx buffer), then the reset/move window command (1470) may include the SN of the next packet to be transmitted. If the RLC Tx 1430 is not aware of the next packet to be transmitted, then the packet's control information may include a bit that indicates that the SN of the packet should be utilized as the new SN by the RLC Rx 1440.

Alternatively, the RLC Tx 1430 may inform the RLC Rx 1440 by sending a SN gap indicator command (1480). The SN gap indicator command (1480) may identify a range of SNs, or individual SNs, that the RLC Rx should not expect to receive. The SN gap indicator command (1480) may be implemented as a control packet, may be a new packet, or an enhancement to an existing packet. Since the SN gap indicator command (1480) may provide a range of SNs, (e.g., between SN1 and SN2), that the RLC Rx 1440 should ignore recovering, the RLC Rx 1440 may still attempt to identify and recover packets the lie before the range, (e.g., before SN1), and request retransmission of the packets via ARQ. With the reset/move window command (1470), the RLC Rx 1440 may ignore identifying and recovering any missing packets the lie before an indicated SN. Additionally, the SN gap indicator command (1480) may also identify more than one missing range of SNs, identify non-missing ranges, or identify individual SNs instead of ranges. If the RLC Tx 1430 is aware of the next packet to be transmitted, (e.g., the next packet is in the RLC Tx buffer), then the SN gap indicator command (1480) may include the SN that represents the upper SN of the range. If the RLC Tx 1430 is not aware of the next packet to be transmitted, then the packet's control information may include a bit that indicates that the SN of the packet should be utilized as the new SN by the RLC Rx 1440.

In an alternative example, the RLC Tx 1430, or the node where the RLC Tx 1430 resides, may perform a check to verify that the packets, or RLC SDUs, received from upper layers have consecutive PDCP SNs prior to transmission. If a missing PDCP SN is detected, such as due to a PDCP SN reset/change in ciphering keys, packet loss, or any other reason, then the RLC Tx 1430 or the node where the RLC Tx 1430 resides, notifies the RLC Rx 1440 or the node where the RLC Rx 1440 resides, via either the reset/move window command (1470) or the SN gap indicator command (1480).

In another alternative example, the RLC Rx 1440 may detect a gap in the SNs while reassembling or reordering the packets. In this scenario, the RLC Rx 1440 may transmit a negative ACK, (i.e., NACK), such as in a status report, identifying the missing PDCP SN, or RLC-specific ARQ SN. At this point, the RLC Tx 1430 may investigate whether it can retransmit the missing packet, and if the packet does not exist, the RLC Tx 1430 again may transmit a reset/move window command (1470) or the SN gap indicator command (1480) to the RLC Rx 1440.

In place of the PDCP SN described above, the RLC may utilize the PDU SN, where the RLC Tx accounts for RLC SDU boundaries when indicating a new RLC PDU SN to be used by the RLC Rx. Since an SDU may be contained in multiple PDUs having consecutive PDU SNs, upon resetting or moving of the window, the RLC Tx advances the new PDU SN to start at the boundary of the next SDU to be transmitted.

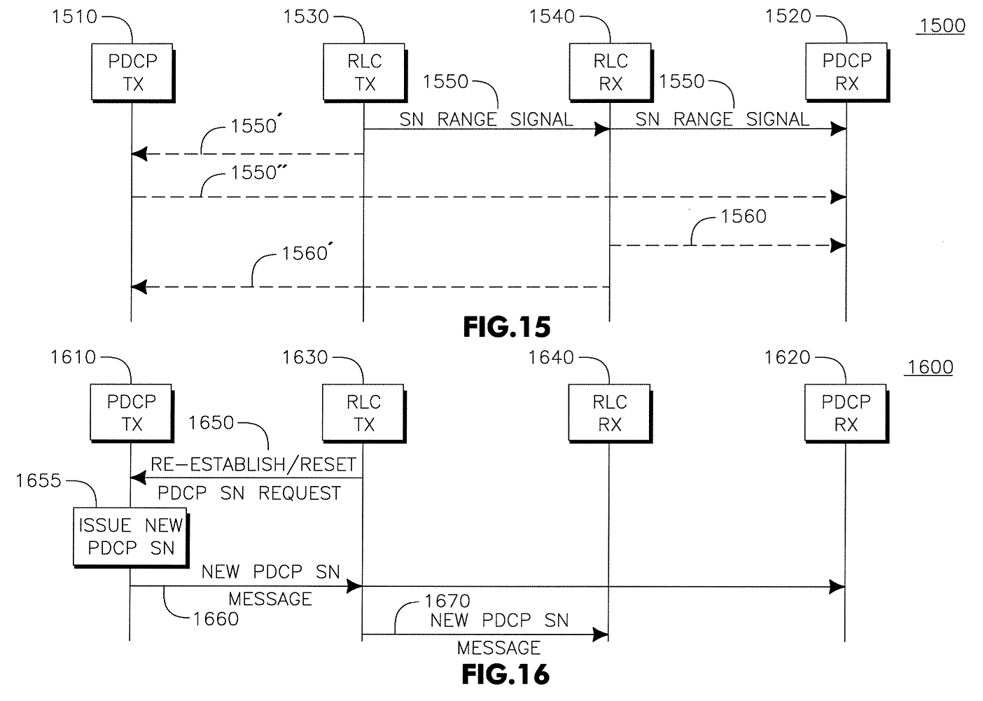

In some scenarios, changes and resets may be initiated by the RLC sublayer. In many cases, these RLC changes may not need to be transmitted to the PDCP sublayer. For example, if the PDCP sublayer is performing reordering, it may be indicated to the PDCP Rx that is should not wait for packets that will never be received. Accordingly, FIG. 15 is an example signal diagram 1500 depicting signaling wherein the PDCP Rx is informed of RLC changes initiated by the RLC sublayer. As shown in FIG. 15, a PDCP Tx 1510, PDCP Rx 1520, RLC Tx 1530, and RLC Rx 1540 are capable of communication with one another. The RLC Tx 1530, in one example, transmits an SN range signal (1550) to the RLC Rx 1540, which in turn signals the information to the PDCP Rx 1520. The SN range signal 1550 notifies the PDCP Rx 1520 that the RLC will not deliver a range of PDCP SNs due to the RLC sublayer resetting or moving the window. Accordingly, the PDCP Rx 1520 should not expect to receive the missing SNs.

Alternatively, the RLC Tx 1530 may inform the PDCP Tx 1510 via an SN range signal (1550′), which the PDCP Tx 1510 forwards (signal 1550″) to the PDCP Rx 1520. The RLC Rx 1540 may also signal the SN range signal to either the PDCP Rx 1520 (signal 1560) or to the PDCP Tx 1510 (signal 1560′).

If the RLC reset function requires that the PDCP layer issues, or starts, from a new PDCP SN, such as in the case of protocol errors, then the PDCP Tx may need to be informed. FIG. 16 is an example signal diagram 1600 depicting signaling wherein a PDCP Tx 1610, a PDCP Rx 1620, an RLC Tx 1630, and an RLC Rx 1640 are capable of communication with one another. The RLC Tx 1630 transmits a re-establish/reset PDCP SN request message (1650) to the PDCP Tx 1610. In one example, the re-establish/reset PDCP SN request message (1650) may be in the form of a local signal or service primitive when both the RLC Tx 1630 and PDCP Tx 1610 reside in the WTRU 510. When the PDCP Tx 1610 receives the re-establish/reset PDCP SN request message (1650), the PDCP Tx 1610 issues the new PDCP SN (1655), and communicates it to the PDCP Rx 1620 via a signaling message, such as new PDCP SN message (1660). The PDCP Tx 1610 also transmits the new PDCP SN message (1660) to the RLC Tx 1630, which forwards the message to the RLC Rx 1640 (signal 1670).

Alternatively, the RLC Rx 1640 may indicate, in the control part of the received packet, that a particular RLC SDU, or PDCP PDU, is the first successfully received packet following an SN gap that was caused by the RLC reset. Upon receiving a packet with such an indicator, the PDCP sublayer does not need to wait for previous missing SNs to be received, and may proceed with performing reordering.

It may also be that, when the RLC resets, there may not be a requirement to coordinate between the RLC and PDCP sublayers. Instead, the RLC simply resets to the next PDCP SN that it has in the RLC Tx 1630 without coordinating with the PDCP sublayer.

In the downlink case, PDCP packets may be lost before arriving at the RLC Tx in the Node B, due to transport network losses at congestion or handover. Accordingly, the signaling described above in exemplary signal diagrams 1400, 1500, 1600, and their alternatives, may be utilized to resolve the loss of PDCP packets in the downlink.

In order to provide information regarding the initial SN from which the RLC sublayer should start, several signaling mechanisms may be employed. For example, since this SN is the SN of the first packet, the initial PDCP SN may be communicated to the RLC or derived by the RLC during the RLC configuration, or setup, phase. Alternatively, the RLC may utilize a control packet where the RLC Tx can inform the RLC Rx of the initial SN that the RLC Tx will start from. In another example, the RLC Tx can utilize a move window command to ensure that the window, or starting SN, of the RLC Rx is synchronized with the RLC Tx. Also, the RLC Tx can poll the RLC Rx to know the SN that the RLC Rx is expecting, and perform SN synchronization based upon the poll results.

For FIGS. 14, 15, and 16 above, the RLC Tx entities and PDCP Tx entities may reside in one particular node, such as the WTRU 510 in the case of uplink traffic and the base station 520 in the case of downlink traffic. Similarly, the RLC Rx entities and PDCP Rx entities may reside in one particular node, such as the base station 520 in the case of uplink traffic and the WTRU 510 in the case of downlink traffic.

Although features and elements are described above in particular combinations, each feature or element can be used alone without the other features and elements or in various combinations with or without other features and elements. The methods or flow charts provided herein may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for performing adaptive sequence numbering, the method comprising:
determining whether or not at least one packet to be transmitted will be segmented;
based upon the segmentation determination, determining whether or not to include a radio link controller (RLC) specific automatic repeat request (ARQ) sequence number (SN) to the packet; and
transmitting the at least one packet.

2. The method of claim 1 wherein the RLC-specific ARQ SN is included when segmentation is performed on the at least one packet.

3. The method of claim 1 wherein the RLC-specific ARQ SN is not included when segmentation is not performed on the at least one packet.

4. The method of claim 3 wherein a packet data convergence protocol (PDCP) SN is reused.

5. The method of claim 1 wherein the RLC-specific ARQ SN is not included when a determination is made that segmentation of the at least one packet results in small resultant packets.

6. The method of claim 1, further comprising receiving an acknowledgment (ACK) for the transmitted at least one packet.

7. The method of claim 1, further comprising adding an indicator to indicate whether or not the RLC-specific ARQ SN is included in the transmitted at least one packet wherein the indicator has a first value indicating the presence of the RLC-specific ARQ SN in the transmitted at least one packet and a second value indicating the absence of the RLC-specific ARQ SN in the transmitted at least one packet.

8. The method of claim 7 wherein the indicator is a bit added to the transmitted at least one packet.

9. The method of claim 8 wherein the transmitted at least one packet is segmented and the RLC-specific ARQ SN and indicator bit are included in each segment.

10. The method of claim 1, further comprising concatenating the at least one packet.

11. The method of claim 10, further comprising adding the RLC-specific ARQ SN to the concatenated packet.

12. The method of claim 10, further comprising adding an indicator to the concatenated packet to indicate whether or not the RLC-specific ARQ SN is included in the concatenated packet wherein the indicator has a first value indicating the presence of the RLC-specific ARQ SN in the concatenated packet and a second value indicating the absence of the RLC-specific ARQ SN in the concatenated packet.

13. A method of adaptive sequence numbering in a wireless communication system, the method comprising:
assigning a first channel in the system a radio link controller (RLC)-specific automatic repeat request (ARQ) sequence number (SN) mode of operation; and
assigning a second channel in the system a reuse of packet data convergence protocol (PDCP) SN mode of operation.

14. The method of claim 13, further comprising specifying the modes of operation for the first and second channel during a setup phase.

15. A method for communicating a cipher key change in a wireless communication system, the method comprising:
changing the cipher key in the wireless communication system;
sending a cipher key change message, wherein the cipher key change message indicates the cipher key change; and
sending a reset/move window command wherein the reset/move window command indicates a new packet data convergence protocol (PDCP) sequence number (SN) that will be used.

16. The method of claim 15 wherein the reset/move window command includes an SN of a next packet to be transmitted.

17. A method for communicating a cipher key change in a wireless communication system, the method comprising:
changing the cipher key in the wireless communication system;
sending a cipher key change message, wherein the cipher key change message indicates the cipher key change; and
sending a sequence number (SN) gap indicator wherein the SN gap indicator identifies SNs.

18. The method of claim 17 wherein the SN gap indicator identifies a range of SNs.

19. The method of claim 17 wherein the SN gap indicator identifies a range of missing SNs.

20. The method of claim 17 wherein the SN gap indicator identifies a range of non-missing SNs.

21. The method of claim 17 wherein the SN gap indicator identifies an individual SN.

22. The method of claim 17 wherein the SN gap indicator identifies a plurality of ranges of missing SNs.

23. The method of claim 17, further comprising ignoring recovering missing packets identified in the SN gap indicator.

24. The method of claim 17 wherein the SN gap indicator is sent in a control packet.

25. The method of claim 17 wherein the SN gap indicator includes an SN representing an upper SN of a range of SNs.

26. A method of communicating changes in a wireless communication system, the method comprising:
transmitting a sequence number (SN) range signal, wherein the SN range signal includes a range of packet data convergence protocol (PDCP) SNs that will not be transmitted; and
ignoring missing SNs.

27. The method of claim 26 wherein a radio link controller transmitter (RLC Tx) transmits the SN range signal to a PDCP Rx via an RLC Rx.

28. The method of claim 26 wherein a radio link controller transmitter (RLC Tx) transmits the SN range signal to a PDCP Tx and the PDCP Tx forwards the signal to a PDCP Rx.

29. The method of claim 26 wherein a radio link controller receiver (RLC Rx) transmits the SN range signal to a PDCP Rx.

30. The method of claim 26 wherein a radio link controller receiver (RLC Rx) transmits the SN range signal to a PDCP Tx and the PDCP Tx forwards the signal to a PDCP Rx.

31. The method of claim 26 wherein a PDCP Tx transmits the SN range signal to a PDCP Rx.

32. The method of claim 26, further comprising sending a re-establish/reset PDCP SN request message.

33. The method of claim 32 wherein the re-establish/reset PDCP SN request message is transmitted from a radio link controller transmitter (RLC Tx) to a PDCP Tx.

34. The method of claim 33 wherein, in response to receiving the re-establish/reset PDCP SN request message, the PDCP Tx issues a new PDCP SN.

35. The method of claim 34, further comprising the PDCP Tx sending a new PDCP SN message to a PDCP receiver (Rx) and the RLC Tx, wherein the new PDCP SN message includes the new PDCP SN.

36. The method of claim 35, further comprising the RLC Tx forwarding the new PDCP SN message to an RLC Rx.

37. A base station in a wireless communication system, the base station comprising:
a receiver;
a transmitter; and
a processor in communication with the receiver and the transmitter, the processor configured to determine whether or not at least one packet to be transmitted will be segmented, based upon the segmentation determination, determine whether or not to include a radio link controller (RLC) specific automatic repeat request (ARQ) sequence number (SN) to the packet, and transmit the at least one packet.

38. The base station of claim 37 wherein the processor is further configured to add an indicator to indicate whether or not the RLC-specific ARQ SN is included in the transmitted at least one packet wherein the indicator has a first value indicating the presence of the RLC-specific ARQ SN in the transmitted at least one packet and a second value indicating the absence of the RLC-specific ARQ SN in the transmitted at least one packet.

39. The base station of claim 37 wherein the processor is further configured to concatenate the at least one packet.

40. A wireless transmit/receive unit (WTRU) in a wireless communication system, the WTRU comprising:
a receiver;
a transmitter; and
a processor in communication with the receiver and the transmitter, the processor configured to determine whether or not at least one packet to be transmitted will be segmented, based upon the segmentation determination, determine whether or not to include a radio link controller (RLC) specific automatic repeat request (ARQ) sequence number (SN) to the packet, and transmit the at least one packet.

41. The WTRU of claim 40 wherein the processor is further configured to add an indicator to indicate whether or not the RLC-specific ARQ SN is included in the transmitted at least one packet wherein the indicator has a first value indicating the presence of the RLC-specific ARQ SN in the transmitted at least one packet and a second value indicating the absence of the RLC-specific ARQ SN in the transmitted at least one packet.

42. The WTRU of claim 40 wherein the processor is further configured to concatenate the at least one packet.
